(19) United States
(12) Patent Application Publication
(10) Pub. No.: US 2011/0265730 A1
(43) Pub. Date: Nov. 3, 2011

(54) Apparatus for the cultivation of molluscan shellfish and other marine species

(76) Inventor: Jon David Farrington, St. Leonard, MD (US)

(21) Appl. No.: 13/097,772

(22) Filed: Apr. 29, 2011

Related U.S. Application Data
(60) Provisional application No. 61/343,514, filed on Apr. 30, 2010.

(51) Int. Cl. A01K 61/00

(52) U.S. Cl. 119/239

(57) ABSTRACT

The invention is an apparatus for the cultivation of marine species, particularly molluscan shellfish such as oysters. The shellfish are cultivated within a rotating cylinder featuring water-permeable walls, and positioned at the water surface by buoyant chambers such that a portion of the cylinder is immersed while the remainder is exposed to the atmosphere. The rotational position of the cylinder is advanced by way of a passive mechanical interaction driven by changes in local water elevations (e.g. tide cycles), thereby creating a repetitive and systematic exposure of the entirety of the cylinder wall to atmospheric desiccation. Furthermore, the rotation of the cylinder promotes a gentle tumbling of the shellfish within, thereby improving product shape and uniformity of growth, as well as enhancing the clearing of accumulating sediments and/or metabolic wastes.

### CROSS-REFERENCE TO RELATED APPLICATIONS

U.S. application Ser. No. 61/343,514; Filing Date: Apr. 30, 210; Farrington, Jon.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

As world populations have increased dramatically in recent decades, so too has harvest pressure on wild fisheries. As a result, great interest has developed in the aquaculture of valuable species, resulting in advancements to the art, particularly with respect to the cultivation of molluscan shellfish. Of particular note is the recent interest in the cultivation shellfish in open waters using containerized, water permeable structures. Containerized methods have proven to provide many advantages over traditional (non-containerized) shellfish cultivation, such as protection from predators, as well as facilitate the hauling of the animals for inspection, maintenance, and harvest. (henceforth called “containers” and/or “containerized methods”).

However, obstacles remain that often hamper the cultivation of shellfish within containerized structures. Of particular note, marine fouling organisms will often rapidly colonize the permeable surfaces of the container itself, reducing water penetration and thereby restricting the flow of food and oxygen to the shellfish within. Compounding this issue, low flow rates will lead to reduced flushing and increased accumulation of metabolic wastes within the container, further restricting flow and altering water chemistry necessary for healthy environment for the cultivated animals. As a result, uncontrolled or unmitigated fouling can lead to stunted growth, or even mortality, among the cultivated shellfish. The application of anti-fouling treatments to the container is not an option, due to highly toxic nature of such treatments and proximity to the shellfish inside. Very typically, treatment to control fouling organisms involves some type of mechanical and labor-intensive activity, requiring either hauling or inversion of the containers from the water.

In addition to fouling growth, static containers promote settling and crowding of the contents within, leading to misshapen shellfish and/or shells that grow into or through the permeable walls, becoming enmeshed and difficult to separate from the container. Either of these situations is costly; the first detracts from product value and the second requires additional labor to remedy.

So while containerized techniques offer many advantages for shellfish cultivation, much of the prior art is hampered by the static nature of the containers. Static containers promote settling and crowding of animals and lead to undesirable traits in growth. Additionally, static containers allow fouling growth to colonize permeable surfaces and stifle water flow to the animals within, leading to stunted growth and/or mortality.

### BRIEF SUMMARY OF THE INVENTION

The invention is an apparatus for the cultivation of marine species, particularly molluscan shellfish such as oysters. The shellfish are cultivated within a rotating cylinder, constructed of water permeable walls, and supported by buoyant chambers. The buoyant chambers are used to position the cylinder at the interface of water and air, in such a fashion that only part of the cylinder is immersed in water while the remainder is exposed to the atmosphere. A simple mechanism is provided to advance the rotational position of the cylinder through a passive interaction with changing elevations of the local water level (e.g. tide cycles).

In this fashion, the apparatus addresses shortcomings in the prior art. In particular, the slow rotation of the partly immersed cylinder provides for a repetitive and systematic exposure of the entirety of the cylinder wall to the atmosphere, thereby preventing the development of fouling organisms by way of desiccation to wind and sun. In conjunction, the rotation of the cylinder causes the animals within to slowly tumble, thereby minimizing the settling and compacting of the shellfish, as well as preventing shell growth from engaging and/or enmeshing the container wall itself. Additionally, the aforementioned actions occur while the shellfish remain submerged within the marine environment, thereby promoting continued feeding and growth. Together, these enhancements lead to faster growth, lower mortality, and better quality shellfish, as well as reducing labor for the aquaculturist. Additionally, the passive design of the rotational mechanism consumes no external power, nor is subject to potential power failures.

### BRIEF DESCRIPTION OF THE SEVERAL VIEWS OF THE DRAWING

The details of the invention will be described in connection with the accompanying drawings in which:

FIG. 1 is a perspective view of a preferred embodiment of the invention

FIG. 2 shows a side elevation view of an alternate embodiment, in which the axis of rotation of the container lies below the center of buoyancy of the buoyant chamber, and the cord contacting the surface of the container is anchored to a stationary object above the apparatus.

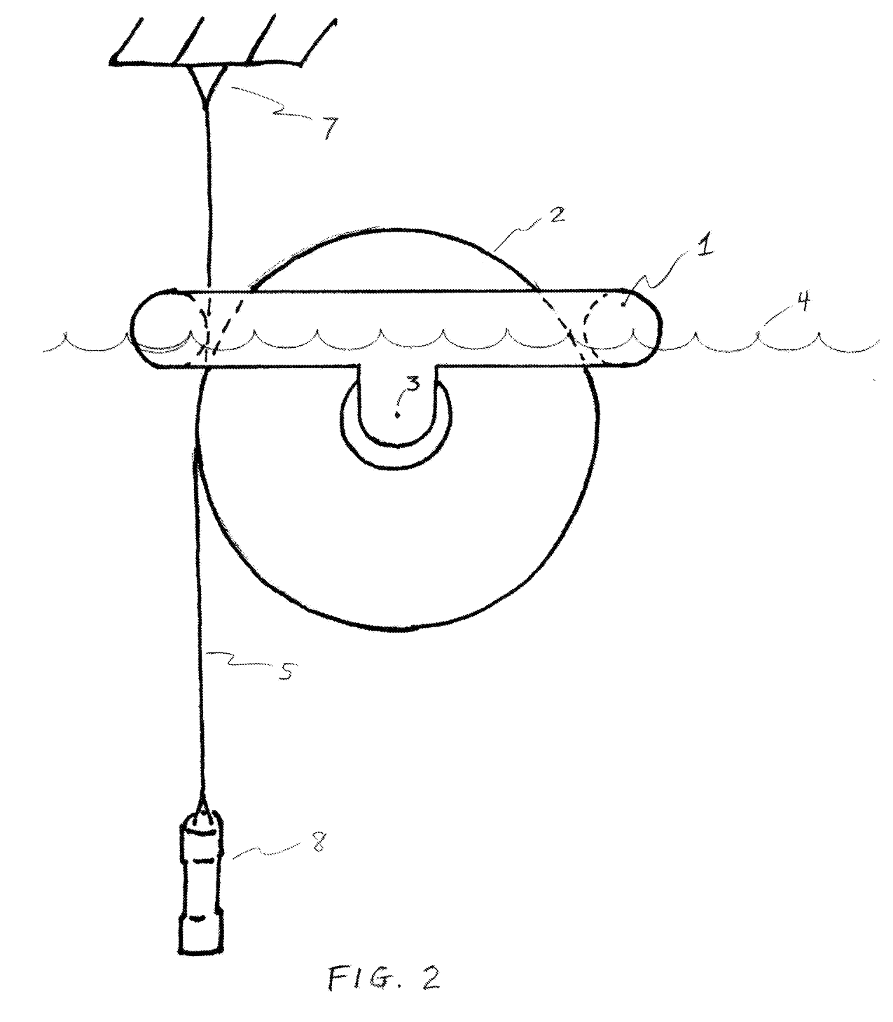

### DETAILED DESCRIPTION OF THE INVENTION

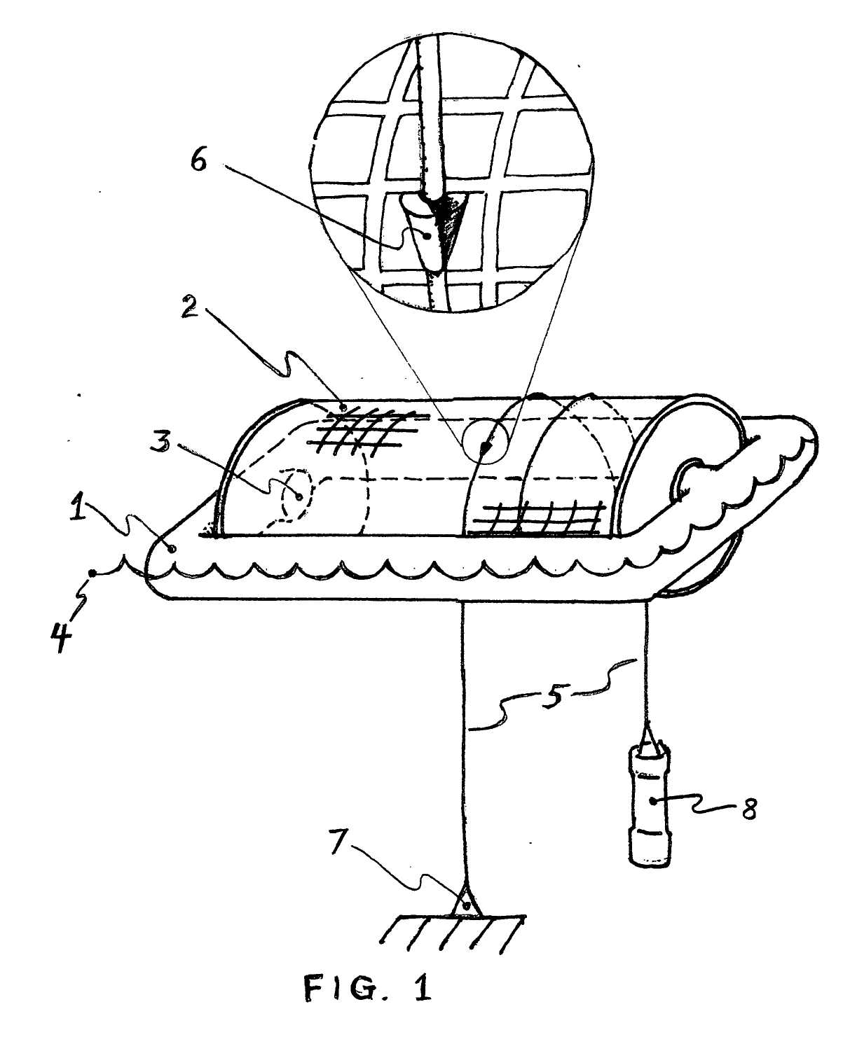

Referring to FIG. 1, a buoyant chamber 1 is used to support a container comprising wire mesh 2 such that the container is permitted to rotate about an axis 3. Additionally, the buoyant chamber maintains the container at an elevation whereby the container intersects with the surface of the body of water 4. Contacting the surface of the container, but not fastened to it, is a cord 5 featuring at least one directional tooth 6. This cord is anchored to a stationary object 7 at one end, while the opposite end of the cord is attached to a tensioning device, such as the weight 8. Due to the directional tooth, the force that can be transmitted from the cord to the container is substantially greater in one of the two primary directions of engagement. When force is applied in one direction, the tooth slips against the container; when force is applied in the opposite direction, there is a positive engagement through which torque sufficient to rotate the container may be applied. In this way, as the elevation of the apparatus oscillates with tidal fluctuations, the rotational orientation of the container is positively and cumulatively advanced in one direction.

What is claimed:

1. An apparatus for the cultivation of marine species, comprising:
A water-permeable container for holding said species within a body of water;
A means for dynamically positioning said container at the local surface of said body of water, regardless of the local elevation of the water, and such that some portion of the container lies below and some portion of the container lies above the surface of said body of water;
A means for incrementally and cumulatively advancing the rotational orientation of said container in a predetermined direction about an axis laying within the plane defined by the local surface of the water; and
A means responsive to changes in elevation of said surface of water to impart said advancement in rotational orientation to said container.
